(19) United States
(12) Patent Application Publication
(10) Pub. No.: US 2016/0152324 A1
(43) Pub. Date: Jun. 2, 2016

(54) FLUIDIC FENCE FOR PERFORMANCE ENHANCEMENT

(71) Applicant: California Institute of Technology, Pasadena, CA (US)

(72) Inventors: Emilio Graff, Altadena, CA (US); Israel Wygnanski, Tucson, AZ (US)

(21) Appl. No.: 14/242,809

(22) Filed: Apr. 1, 2014

Related U.S. Application Data
(60) Provisional application No. 61/807,196, filed on Apr. 1, 2013.

(51) Int. Cl. B64C 21/10

(52) U.S. Cl. CPC B64C 21/10

(57) ABSTRACT

A system, apparatus, device, and method for controlling fluid flow, including one or more devices generating one or more secondary fluid flow structures, wherein the fluid flow structures emanate from the aerodynamic or hydrodynamic surface, have a strength that is controlled independently of the primary flow, and enhance the aerodynamic or hydrodynamic force generated by primary flow predominantly by changing direction of said primary flow whether the flow is attached or separated from the surface, and/or interrupting and re-starting said primary flow forming regions that are not directly affected by the fluid flow structure regardless of whether said primary flow is attached or separated.

### CROSS REFERENCE TO RELATED APPLICATIONS

This application claims the benefit under 35 U.S.C. Section 119(e) of co-pending and commonly-assigned U.S. Provisional Patent Application Ser. No. 61/807,196, filed on Apr. 1, 2013, by Emilio Castano Graff and Israel Wygnanski, entitled “FLUIDIC FENCE FOR PERFORMANCE ENHANCEMENT,” attorneys' docket number 176.97-US-P1 (CIT-6507-P), which application is incorporated by reference herein.

### STATEMENT REGARDING FEDERALLY SPONSORED RESEARCH AND DEVELOPMENT

This invention was made with government support under NNL12AA09C awarded by NASA Langley Research Center. The government has certain rights in the invention.

### BACKGROUND OF THE INVENTION

1. Field of the Invention

This invention relates to methods, devices, systems, and apparatus for altering primary fluid flow.

2. Description of the Related Art

(Note: This application references a number of different publications as indicated throughout the specification by one or more reference numbers within brackets, e.g., [x]. A list of these different publications ordered according to these reference numbers can be found below in the section entitled “References.” Each of these publications is incorporated by reference herein.)

Improving the efficiency of fluid flow over and aerodynamic surface (e.g., air flow over an aircraft wing) is an active area of research and useful for lowering energy expenditures (e.g., fuel costs of commercial airline flights).

Conventional methods include using active flow actuators [9-11] to enhance performance by re-attaching separated flow globally and directly across the entire wing of an aircraft. However, such methods are more invasive and require large expenditures of energy which can make their implementation impractical.

### SUMMARY OF THE INVENTION

One or more embodiments of the present invention describe methods and systems of altering primary flow direction over aerodynamic and hydrodynamic surfaces generating force. The method/system/apparatus can use one or more devices to generate one or more secondary fluid flow structures. The secondary fluid flow structures can emanate from the aerodynamic or hydrodynamic surface, have a strength that is controlled independently of the primary flow, and enhance the aerodynamic or hydrodynamic force generated by primary flow predominantly by: changing direction of said primary flow whether the flow is attached or separated from the surface, and/or interrupting and re-starting said primary flow forming regions that are not directly affected by the fluid flow structure regardless of whether said primary flow is attached or separated.

The changing of the direction can be along the aerodynamic or hydrodynamic surface and may be substantially not normal to the surface.

The aerodynamic force can be enhanced without the use of mechanical devices that alter contours of the surface. The fluid flow structure can prevent separation by redirecting the primary flow, thus using less energy than is required to generate a fluid flow structure that can re-attach the primary flow. The fluid flow structure can be generated using less energy than is required to generate a fluid flow structure that can re-attach the primary flow (e.g., the energy may be no more than 15% of that required to re-attach the primary flow, and/or the secondary fluid flow structures can directly affect 20% or less of the primary flow).

In one or more embodiments, most of the primary flow may still separate from the lifting surface but the aerodynamic force generated has still increased.

The fluid flow structure can be generated by at least one of a jet of fluid, a synthetic jet actuator, a sweeping flow actuator, a plasma actuator, unsteady valves, oscillators, combustion, piezoelectric flaps, active dimples, single dielectric barrier discharge, spark jet, or electromagnetic interference.

The aerodynamic surface can be rotating (e.g., as used in a windmill, compressor, turbine, propeller). The aerodynamic surface can be a helicopter rotor blade and the aerodynamic force can be lift or a side force.

One or more embodiments can use a single secondary fluid flow structure consisting of one fluid stream extending along a chordwise direction and at a spanwise location.

In one or more embodiments, one or more locations of the devices can generate the secondary fluid flow structures that divide the surface into equal spanwise sections.

The direction of said primary flow over the surface can be changed from a span wise direction towards a free-stream direction. The primary flow that is interrupted can be primarily in a spanwise direction.

The fluid flow structure can comprises at least one fluid stream generated at a leading edge of the aerodynamic surface comprising a wing and extending along an entire chord of the wing.

The fluid flow structure can change the direction of said flow when said flow is attached and separated.

One or more embodiments of the invention further disclose a method/apparatus/device/system for controlling or diverting primary flow into or away from an intake, comprising using one or more devices generating one or more secondary fluid flow structures, wherein the secondary fluid flow structures have a strength that is controlled independently of the primary flow, and vary an amount of primary flow entering the intake by: changing direction of said primary flow, and/or interrupting and re-starting said primary flow.

### BRIEF DESCRIPTION OF THE DRAWINGS

Referring now to the drawings in which like reference numbers represent corresponding parts throughout:

FIGS. 1(a) and (b) illustrate a fluidic fence system interrupting spanwise flow, according to one or more embodiments of the invention, wherein the images show tuft visualizations of the flow over a model wing in a wind tunnel, FIG. 1(a) shows the flow over the wing with the system OFF, and FIG. 1(b) shows the fluidic fence system comprised of 5 sweeping jets that are turned ON (jet location and orientation are depicted with the arrows 100, Cμ˜2%).

FIGS. 2(a)-(d) shows a fluidic fence system redirecting spanwise flow, according to one or more embodiments, wherein these images show tuft visualizations of the flow over a model wing in a wind tunnel, FIG. 2(a) shows the flow over the wing with the system OFF, FIG. 2(b) shows a fluidic fence system comprised of 5 sweeping jets that are turned ON at low power (Cμ=0.1%; jet location and orientation are depicted with the arrows 200), FIG. 2(c) is a close up of FIG. 2(a) for the region enclosed in the rectangle R, and FIG. 2(d) is a close up of FIG. 2(b) for the region enclosed by the rectangle R.

FIG. 3 illustrates a fluidic fence system redirecting flow, according to one or more embodiments, showing the difference between the baseline case (fluidic fence OFF) and the fluidic fence system of

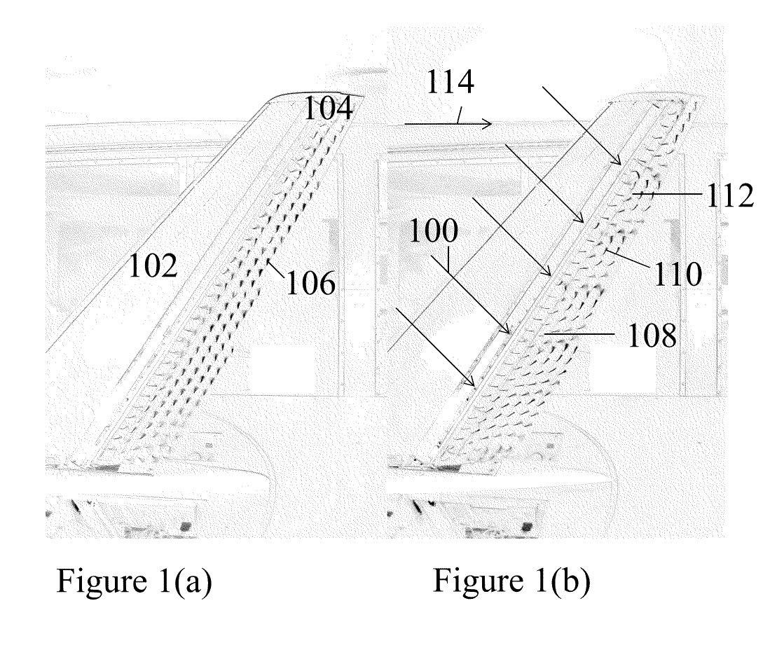

FIG. 1 at the lowest power setting.

FIG. 4 illustrates the effects of blowing out of six actuators (labeled 2-6) on the flow over the model A rudder (FIG. 4(a)) and on the change of its surface pressure (FIG. 4(b)), for Sp=15%, Cμ=0.1% and 6=60%, according to one or more embodiments.

FIG. 5 shows the effect of small jets on the leading edge flow over a delta wing at incidence, showing (a) Installation of 4 small jet nozzles; (b) Baseline flow showing symmetric vortex breakdown on both sides; (c) Elevation view corresponding to (b); and (d) flattening of the leading edge vortex by injection of fluid in the cross flow plane.

FIG. 6(a)-(b) show the effect of steady jets and their inclination on the force generated by model A and the spanwise pressure distribution near the rudder hinge corresponding to Sp=12%, Cμ=0.3% and δ=60%, according to one or more embodiments.

FIG. 7 shows (a) tuft visualization of the surface flow over a deflected rudder with sparse actuation, according to one or more embodiments, (b) a plan view of a MIG-19 with fences, (c) an EMB 145 wing tip with a fence, and (d) a Boeing 737 nacelle with a fence.

FIG. 8 shows (a) spanwise flow over a simple swept back wing and over (b) an airplane model [28].

FIG. 9 shows (a) the vertical stabilizer set up in the Lucas wind tunnel (taken from [23]) used to take measurements in one or more embodiments.

FIG. 10 shows a photo of a sweeping jet as used in one or more embodiments of the invention.

FIG. 11(a) shows the efficiency of different actuator spacings at δR=60%, β=0° and U_{∞}=40 m/s with actuators, with A_{act}=0.6 (arrows pointing up indicate Uj=Uc; arrows pointing down indicate Uj=3·U∞), wherein the pictures in FIGS. 11(b)-(c) show the alteration of flow direction by Active Flow Control (AFC), wherein Cμ=0.1% & δR=40% for FIG. 11(b) and Cμ=2.0% & δR=40% for FIG. 11(c) (taken from [23]), and according to one or more embodiments of the invention.

FIG. 12 shows typical behavior, separation control vs. fluidic fence according to one or more embodiments, on a swept, tapered wing with separated flow over a simple flap.

FIGS. 13(a)-(b) illustrate a fluidic fence used to reduce flow into an intake, according to one or more embodiments, wherein FIG. 13(a) shows the normal flow (fence OFF) and streamlines show flow easily entering the vent, FIG. 13(b) shows the fence ON.

FIGS. 14(a)-(b) show a fluidic fence used to increase flow into an intake, according to one or more embodiments, wherein FIG. 14(a) shows the normal flow (fence OFF) and FIG. 14(b) shows the fence ON.

FIGS. 15(a)-(b) show a fluidic fence system on a rotor blade, according to one or more embodiments, wherein FIG. 15(a) shows a possible flow field on a rotating airfoil, for example, on a wind mill, propeller, compressor, turbine, helicopter rotor, etc., with the fence system OFF, and FIG. 15(b) shows the fence system ON.

FIGS. 16(a)-(b) show a fluidic fence system on a swept wing, according to one or more embodiments, wherein FIG. 16(a) shows a fluidic fence system in the redirection regime, and FIG. 16(b) shows a fluidic fence system in the interruption regime and stronger fluid structures (4) serve to reset (5) the spanwise flow but still allow it to develop in the regions between fluidic fence devices (6).

FIG. 17 is a flowchart illustrating a method according to one or more embodiments of the invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Nomenclature (See Also [25-26]
A=sweep back angle at the quarter chord line [deg]
b=span [m]
c=chord [m]
A_{ref}=projected area of wing [m²]
ρ_{∞}=density of the free stream [kg m⁻³]
P_{∞}=static pressure of the free stream [Pa]
U_{∞}=speed of the free stream [m sec⁻¹]
Re=Reynolds number based on the mean aerodynamic chord
Q=volumetric flow rate [m³ sec⁻¹]
C_{Q}=volumetric flow (incompressible mass flow) coefficient,

$$\frac{Q}{{A}_{ref} {U}_{∞}}$$

A_{act}=exit orifice area of the nozzle [normalized by the largest nozzle]

Uⱼₑₜ=volumetric orifice flow per unit area (incompressible speed),

$$\frac{\text{?}}{\text{?}} [ m {sec}^{- 1} ]$$

$$\text{?} \text{indicates text missing or illegible when filed}$$

n=number of functioning jets
C_{μ}=incompressible momentum coefficient,

$$2 \frac{{nA}_{act}}{{A}_{ref}} {( \frac{{U}_{jet}}{{U}_{∞}} )}^{2} [ \% = \times 0.01 ]$$

P_{c}=static pressure in the plenum chamber supplying the actuators [Pa]
γ=ratio of specific heats (1.4)
C_{Π}=adiabatic power coefficient,

$${C}_{Π} = \frac{\frac{γ}{γ - 1} {P}_{∞} [ {( \frac{\text{?}}{\text{?}} )}^{\frac{γ - 1}{γ}} - 1 ]}{\text{?} \text{?} \text{?} \text{?}}$$

$$\text{?} \text{indicates text missing or illegible when filed}$$

β=angle of incidence [deg]
β_{R}=rudder deflection angle [%, normalized by an arbitrary maximum]
C_{Yn}=side force coefficient [normalized by the baseline side force at β_{R}=60% and β=0° ]; for a given force F, the coefficient C is defined as

$$C = \frac{F}{\text{?} \text{?} \text{?}}$$

$$\text{?} \text{indicates text missing or illegible when filed}$$

C_{Dn}=drag force coefficient [normalized by the baseline drag force at β_{R}=60% and β=0° ]
C_{P}=pressure coefficient,

$$\frac{\text{?}}{\text{?} \text{?} \text{?}}$$

$$\text{?} \text{indicates text missing or illegible when filed}$$

Sp=spacing between active actuators as a fraction of span (%)

Technical Description

For a straight-winged airplane, the first limit in speed, aerodynamically speaking, is the wave drag over the wing—that is, as the airplane increases speed, the flow may become locally sonic over curved surfaces and thus form a shock wave. The energy expended in maintaining this shock can be considered a component of the total drag of the airplane, thus the name wave drag.

Swept back wings allow airplanes to travel faster simply because the angle of the shock is determined by the sweep angle Λ of the wing. The shock can only affect the velocity component perpendicular V⊥ to the leading edge, thus the effective strength of the shock is reduced by the cosine of the angle Λ. Since it is the airspeed reduced by the cosine factor that effectively determines the speed limit of the aircraft, the airspeed can be increased more and more the higher the cosine factor, thus pushing towards higher sweep angles. See [13] for illustration of sweep angle Λ, velocity component V⊥=Vₒ sin Λ, and velocity component V_{∥}=Vₒ cos Λ.

As the airplane slows down (say, for landing), two things happen. First, viscous effects become more important (boundary layer grows thicker). Second, the angle of attack or effective camber (e.g., from putting down flaps) will increase to increase the lift coefficient so that the required lift force is maintained. These conditions favor flow separation or “stall”. In a swept wing, due to the spanwise flow component, the separation starts at the tip of the wing and this has several negative effects (as opposed to starting at the root). First, since the wing tip has a large moment arm on the fuselage, small changes in the lift distribution there due to inherent asymmetries will produce large changes in the rolling moment. Second, because the lift distribution on a swept-back wing has a fore-aft component, losing lift at the tip can change the position of the lift center relative to the center of gravity dramatically thus inducing changes in pitching moment which, in this case, actually works against maneuvering to remove the stall condition.

To alleviate these problems at high lift conditions, some designers have added chord-wise fences on highly swept wings. They can be seen, for example, in the MiG 15 [14-15] (many aircraft employed boundary layer fences to alleviate this problem [16-19]). These fences serve to interrupt the span-wise flow and alleviate the tip separation problem as well as help to redirect the flow in the fore-aft direction, which increases lift. However, at cruise they are unneeded and thus produce only drag, both from the point of view of added surface area (skin friction) and from the added vorticity generated at the intersection of the boundary layers of the wing and the fence. The vortex generated at the intersection represents an energy loss and thus is also considered drag.

Modern airplane designers have selected a sweep angle which is a balance between the negative effects at low speed and the increase in cruising speed. This angle is typically around 30 degrees.

The boundary layer fences are not the only solution to low-speed handling problems. Vortilons are effectively wing fences that are attached to the underside of the wing and they protrude upstream of the leading edge. They align locally the flow with the flight direction but their drag penalty is smaller since the local flow speed is lower than it is on top of the wing. At high angles of incidence (i.e. at a reduced speed) they generate vortices that follow the wing's upper surface that diverts the flow and reduces the spanwise component of velocity on the upper surface. Vortilons were used to ameliorate the deep stall problem on the DC-9 and they are currently used on the ERJ 145 family of jets. In this case four vortilons are placed on the wing upstream of the airplane's ailerons.

Passive mechanical devices like fences and vortilons are employed elsewhere [20]. In modern jet-liners, the engine Nacelles sit below the wing, in front of the leading edge. As the angle of attack increases, the wake of the nacelle interferes with the wing and can significantly affect its lift. U.S. Pat. No. 4,540,143 [20] shows one solution, in which a combined vortex-generator/fence device creates and guides a streamwise vortex over the wing to control the effect of the wake of the nacelle.

Rotor blades experience similar aerodynamic effects as do swept wings due to the rotation. The change in speed with radius generates a spanwise flow along the rotor blades. Fences, like those on swept wings, can be found on rotor blades, e.g. on horizontal windmills.

Fences, vortilons, vortex generators, and other such devices have the primary disadvantage in that they are inflexible. That is, their effect depends entirely on flight conditions (speed, angle of attack) and cannot be “turned off”, and they consume energy even when their effect is minimal or unneeded.

One or more embodiments of the present invention present an ideal solution in the form of a fluidic fence. Instead of building fences out of rigid material which have a fixed shape and are always protruding into the flow, the fence is generated by a flow structure, e.g., a jet of air. If the jet is low speed, the system works similarly to several very thin fences. This is because the jet has more time to spread and so it affects the flow over the surface more globally, although to a small extent. If the jet is high speed, it has less time to spread (if it's supersonic it will automatically spread less than a subsonic jet), thereby working like a small number of long, thick fences (like those seen, for example, on the MiG15). With that arrangement, the spanwise flow is effectively reset at each fluidic fence thereby significantly reducing the negative effects of a swept wing. Moreover, in this scenario the jets are pulling a significant amount of air from the neighboring regions so they have an additional benefit over solid fences in that, whereas a solid fence is actually slowing down the fluid near it (due to the viscous effects and the formation of a boundary layer), the fluidic fence is actually accelerating the fluid.

The fluidic fence according to one or more embodiments of the invention has another variable aspect with respect to a solid one. Given a certain fluidic fence velocity, varying the speed of the airplane changes the ratio between the two speeds, and thus the bending of the fence with respect to the airflow over the wing. In other words, if the fluidic fence is positioned to exit perpendicular to the leading edge, then at zero speed it will continue to blow in this direction; as the airplane speeds up the resulting fluidic fence will be bent more and more in the direction of the stream. Thus by manipulating the fence jet speed relative to the craft speed, the shape of the fence can be altered. Moreover, the small nozzles that can be required to produce the fence jets would sit flush with the surface and add a very small amount of drag, if any. Thus when the fence is unneeded it can be completely turned off. These characteristics present an enormous advantage over a solid fence in many situations.

One should be clear to note that in a fluidic fence system according to one or more embodiments there need be no moving parts, that is, the variability in operation described above, for one or more embodiments, is only in the pressure and flow rate of the fluid being pumped. The spreading (or lack thereof) of the fluidic fences are a physical phenomenon and is not achieved by altering anything other than the amount of fluid being used. It should also be noted that applications are not limited to air flows, i.e., in the above description “air” can be replaced with “fluid”, where this represents gasses, liquids, fluid-like solids (such as fine granules), and multi-phase situations (such as liquid fences in air flow).

The position and size of the individual fluidic fences form part of an optimization problem given the geometry of the aerodynamic surface whose performance is to be managed in this way. This does not preclude multiple solutions to the same problem, that is, if the optimum spacing between fence jets is 10″ but there are two optimum positions, the system may be made by installing jets at 5″ intervals and using any subset of them during particular operational modes. To avoid moving parts this can be done by simple valving in the plumbing system. The angle of the jets and exit location can also be manipulated, either with moving parts or by fluidic control (a “steerable” jet).

The devices used for generating fluidic fences can be the same employed in many active flow control (separation or circulation control) applications. Reattaching separated flow requires a lot more energy input than does the fluidic fence according to one or more embodiments. Because actuators are inherently limited in usable power range, typically this means that separation control applications will require more actuators. On a typical wing application, for example, a fluidic fence system may employ 4 or 5 actuators whereas a separation control system will require on the order of 6 times as many.

1. Interruption of Flow Embodiment

FIGS. 1(a) and (b) illustrate a method of, and system for, altering primary flow direction over aerodynamic surfaces generating force according to one or more embodiments. FIG. 1 (b) illustrates using one or more devices to generate one or more secondary fluid flow structures 100, wherein the fluid flow structures 100 emanate from a aerodynamic surface 100 of a wing (the wing having a simple flap 104), have a strength that is controlled independently of the primary flow 106 (shown in FIG. 1(a)), and enhance the aerodynamic force generated by primary flow 106 predominantly by interrupting 108 and re-starting 110 said primary flow 106 forming regions 112 that are not directly affected by the fluid flow structure 100 regardless of whether said primary flow 106 is attached or separated. Also shown is the direction 114 of the free stream.

Note how in FIG. 1(a), the primary flow 106 is mostly from root to tip (bottom to top of image) whereas FIG. 1(b) shows that the fluidic fences are capable of interrupting the flow, forming cells between them where the spanwise flow is made to restart. These two images illustrate a 36% increase in the lift of the wing due to the secondary fluid flow structures 100.

2. Changing Flow Direction Embodiment

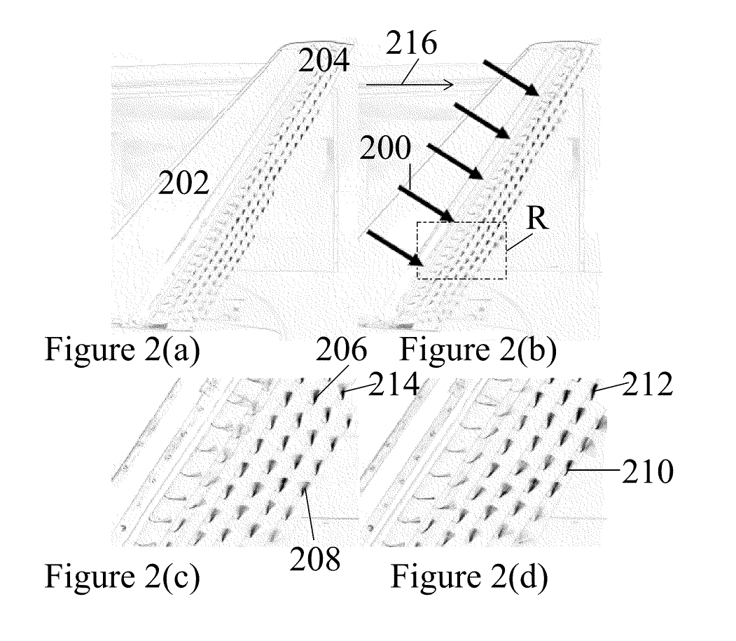

FIG. 2(a)-(d) illustrate a method of, and system for, altering primary flow direction over aerodynamic generating force, comprising using one or more devices to generate one or more secondary fluid flow structures, wherein the fluid flow structures emanate from an aerodynamic surface 200 of a wing (having a simple flap 204), have a strength that is controlled independently of the primary flow 206 (illustrated in FIG. 2(c)), and enhance the aerodynamic force generated by primary flow 206 predominantly by changing direction of said primary flow 206 whether the flow is attached or separated from the surface.

In FIG. 2(a)-(d), the flow remains largely separated as indicated by the “arcs”208 formed by the tufts 210 in the long exposure photos. When the flow is separated it becomes pretty unsteady. Because of the long exposure, the camera captures the movement of the tufts as a fan. Using a flash, a bunch of thin tufts but going in different directions in each picture would be observed.

However, the flow has been redirected slightly (see zoomed in regions FIG. 2(d)) over the majority of the wing. This case represents an 18% increase in lift due to the fluidic fence.

In FIGS. 2(d) and 2(b), the darker regions 212 of the tuft exposure are more deflected to the right than the darker regions 214 of the tuft exposure in FIG. 2(a) and FIG. 2(c). The mean flow has moved more streamwise. The direction 216 of the free stream is also shown.

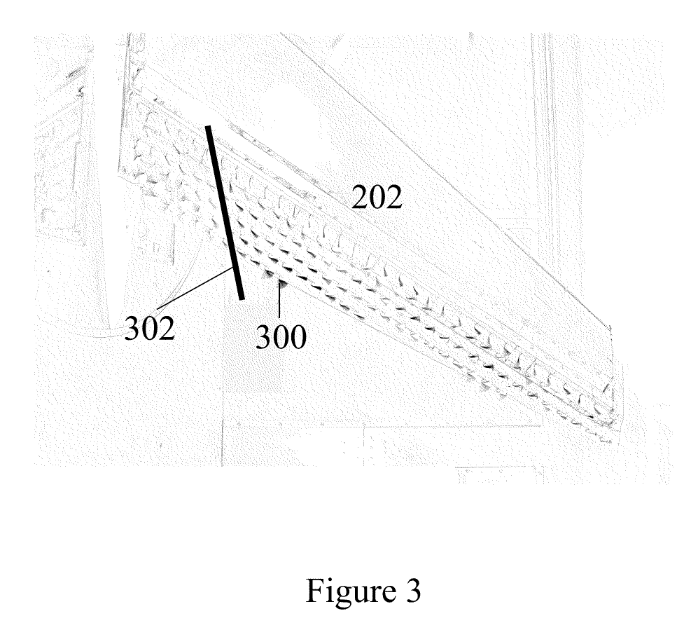

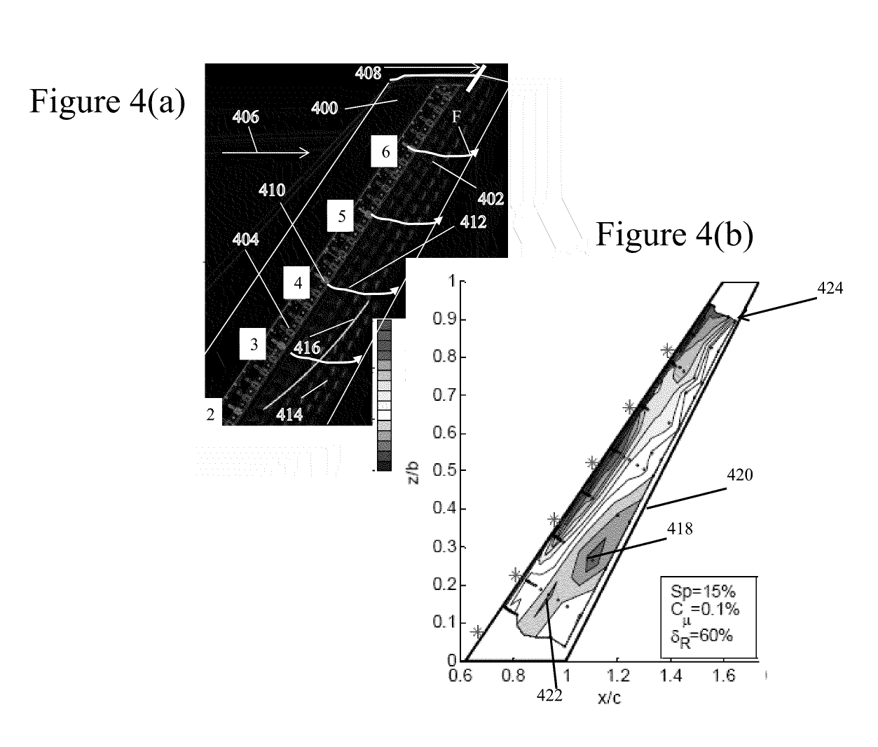

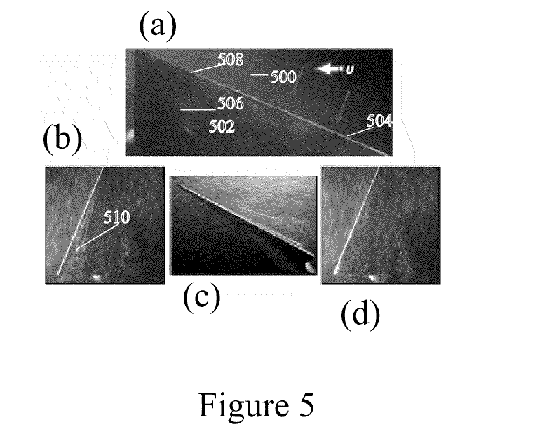

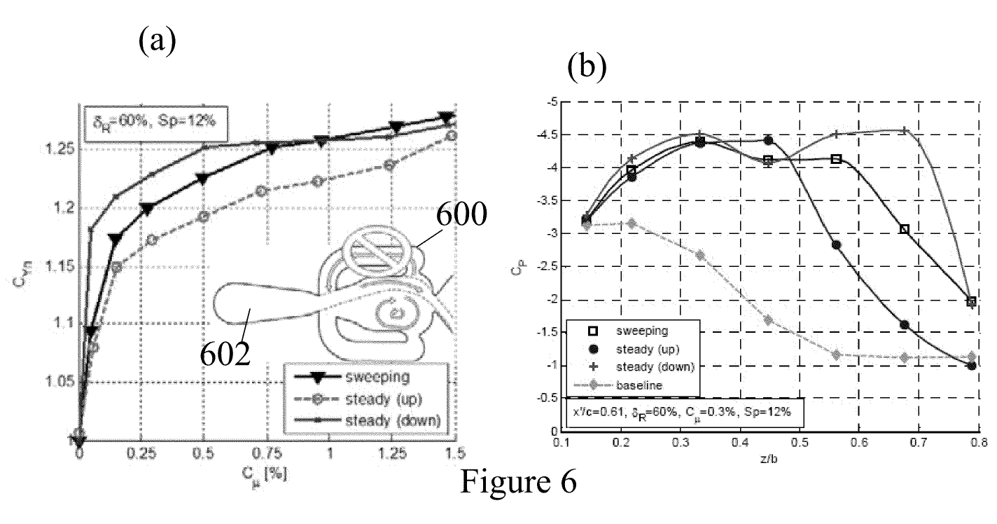

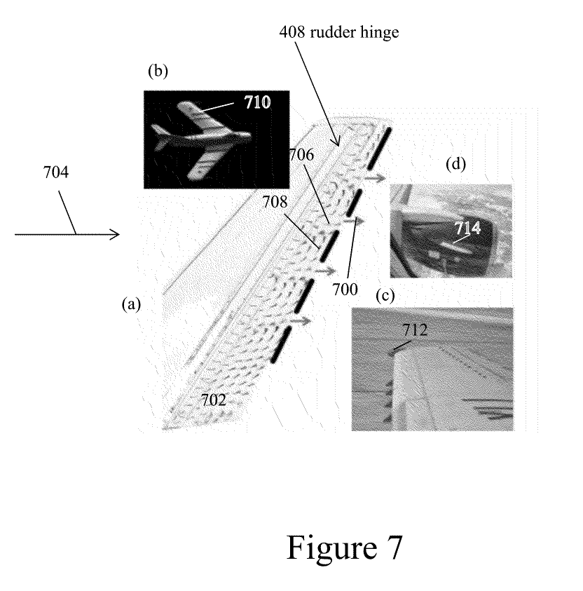

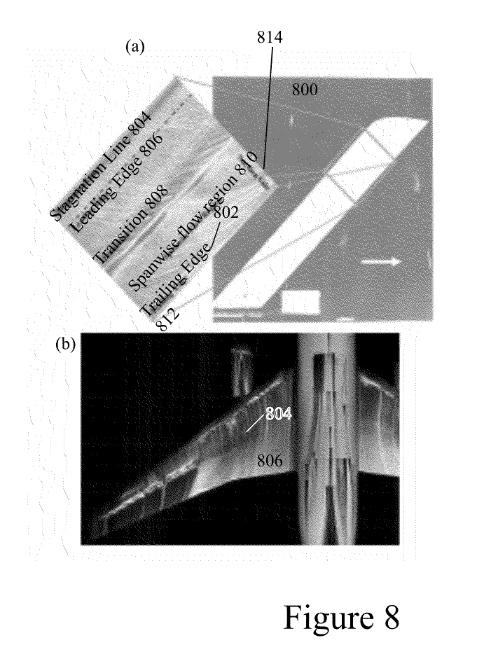

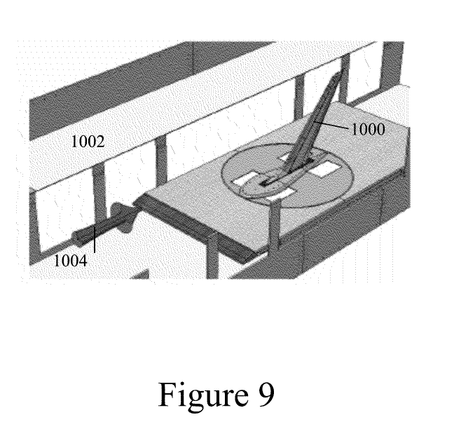

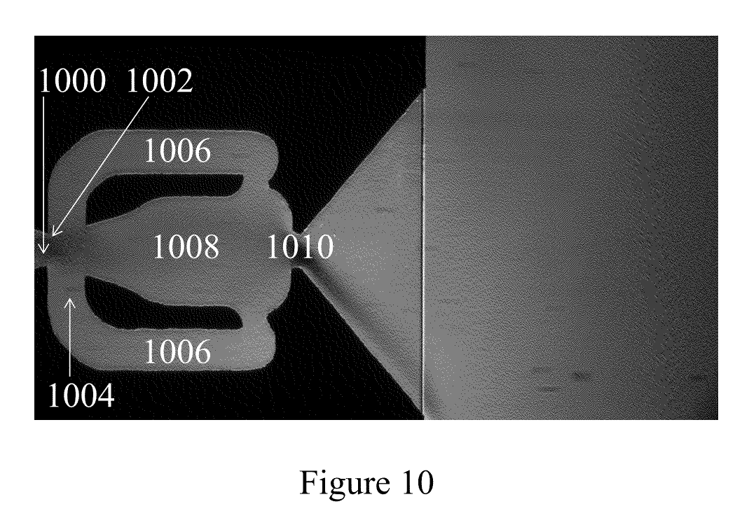

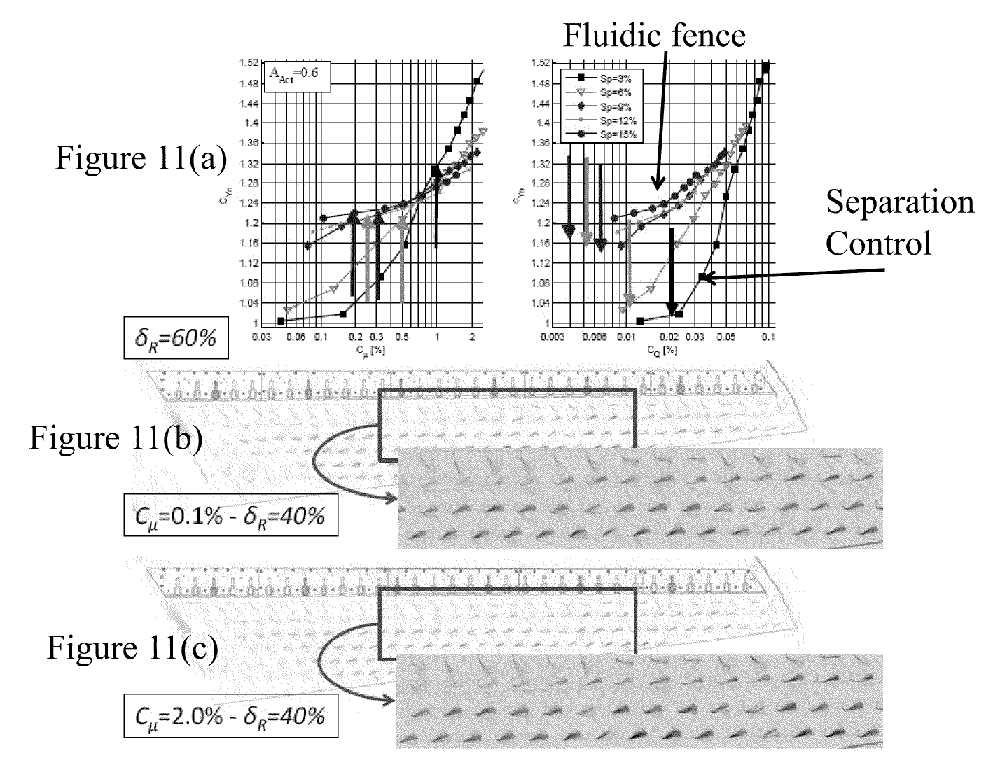

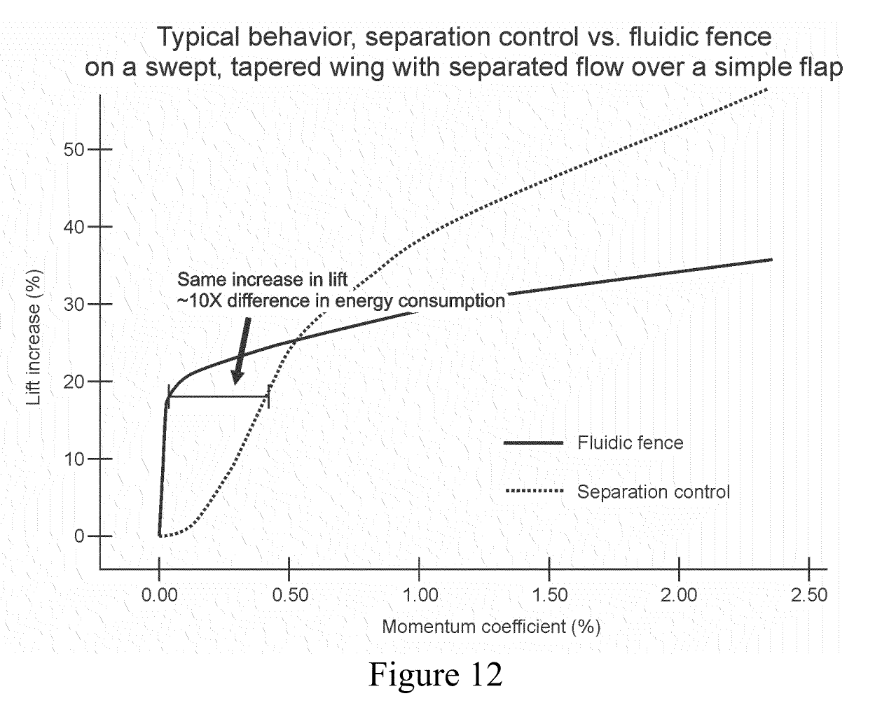

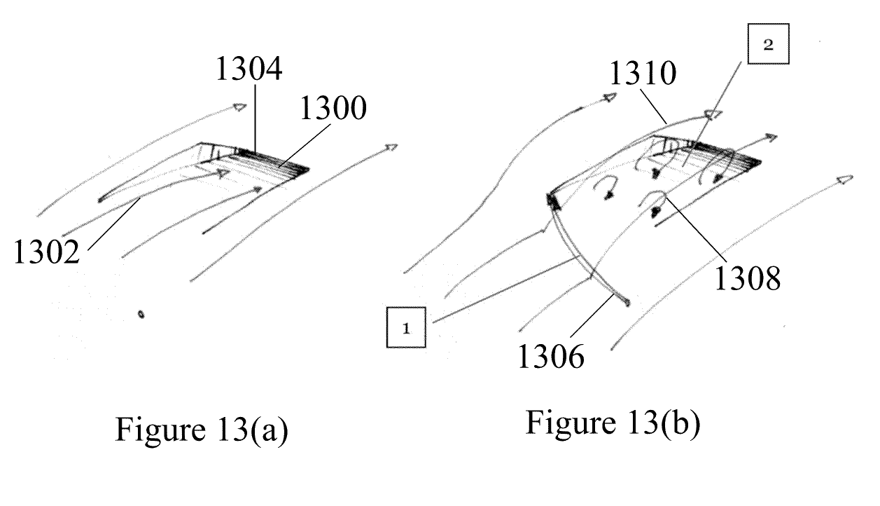

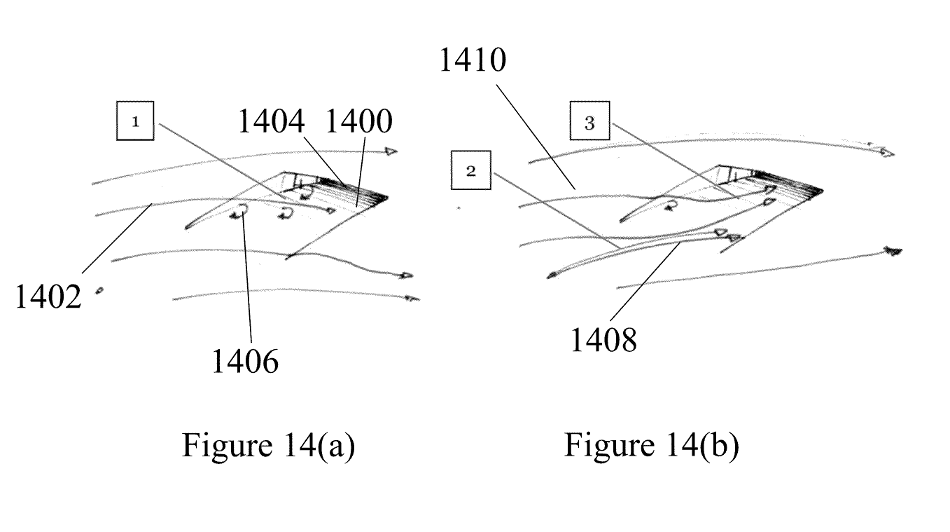

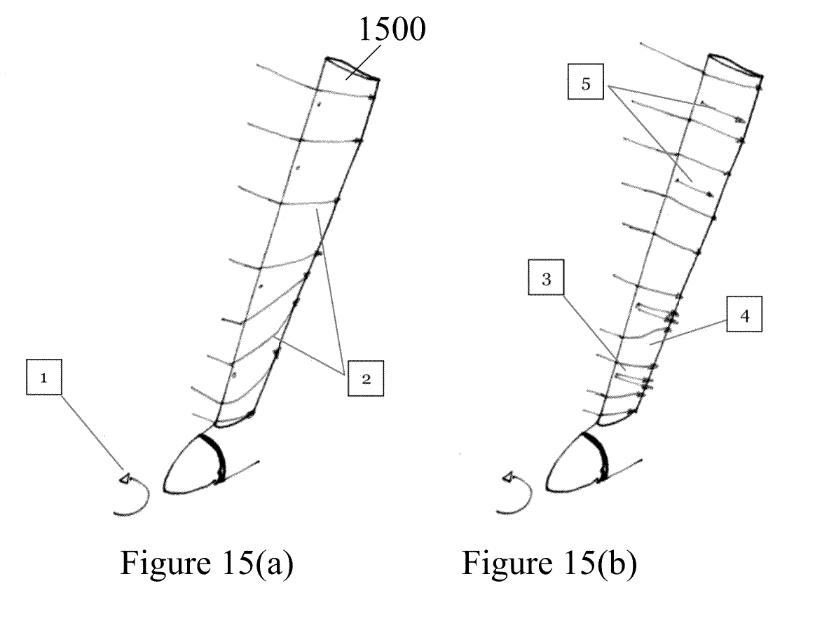

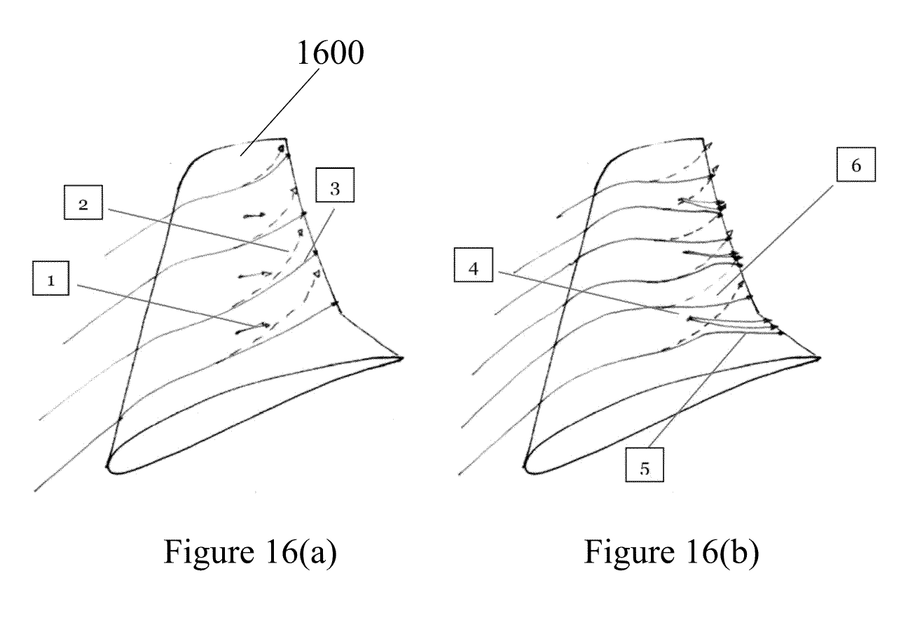

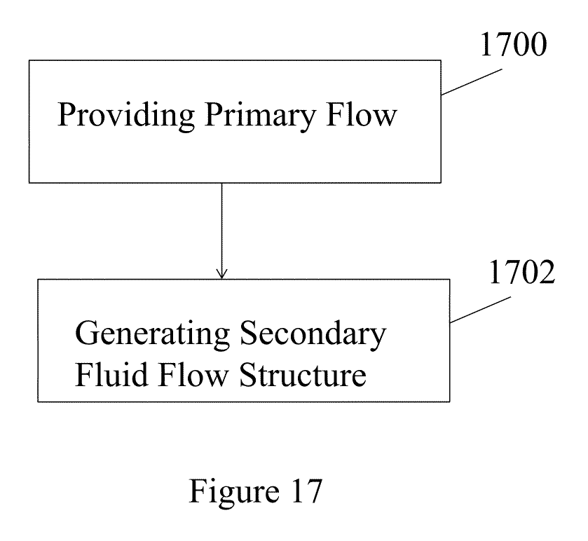

FIG. 3 illustrates a fluidic fence system redirecting flow, according to one or more embodiments, showing the difference between the baseline case (fluidic fence OFF) and the fluidic fence system of

FIG. 1 at the lowest power setting. Where thick black tufts 300 appear, the fence has made the largest difference. The region to the left of the black line 302 is unaffected because it is before the first jet. The region to the right of the line 302 sees a change in direction of the bulk flow due to the fluidic fence. Separation is indicated by tufts that form a “fan” shape; comparison with the left side of

FIG. 1 shows that the fluidic fence has done little or nothing to reattach separated flow. This case represents an 18% increase in lift and would be indistinguishable if presented in a left/right fashion as in

FIG. 1.

3. Further Results and Analysis

Flow visualizations are indicated by tufts that are pieces of yarn that move in the flow to illustrate the flow direction. In flow visualizations for one or more embodiments, a thin line indicates the tuft is steady and indicates that the flow is attached there. If you see a “fan” shape (little arched triangles) it indicates the tuft is oscillating wildly, indicating separated flow.

FIG. 4(a) illustrates an embodiment (wing 400 with simple flap or rudder 402) with every fifth actuator 404 activated (Sp=15%) at δ=60%, where an increase in C_{L} of approximately 20% was achieved at the smallest values of Cμ measurable (i.e. Cμ≈0.1%). At this Sp there was hardly a possibility that adjacent sweeping jets would interact and cover a substantial fraction of the rudder 402 area forcing two dimensional type of reattachment of the flow to the surface. Thus, the main effect of the actuation is the redirection of the flow toward the direction of the free stream 406. Also shown in the rudder hinge 408.

The active jets in FIG. 4 are highlighted in red 410 as are the tufts 412 photographed during actuation. The green tufts 414 represent the baseline condition. The area affected most by those relatively weak and sparse jets is the lower ⅓ of the rudder surface (below and to the right of the white curve 416 in FIG. 4) where the red tufts 412 are redirected toward the free stream 406. It is almost a triangular area extending from the nozzle of actuator (2) to the trailing edge opposite to actuator (4). The jet flow creating the fluid flow structure is also illustrated by the white arrow F in FIG. 4.

The change in the pressure over the rudder 402 from the baseline condition of totally separated flow to the one created by the weak actuation at Cμ=0.1% is shown in FIG. 4(b). The region 418 near the trailing edge 420 where the pressure was increased by the blowing corresponds to the area where the tufts 412 point more in the direction of the free stream 406. This change in direction was caused mostly by actuator (2) because the flow influenced by (1) was also influenced by the corner vortex created by the air seeping through the gap at the root of the rudder.

The separated free shear layer originating at the trailing edge of the stabilizer is converted into a bubble 422 to the left and above of the white curve 416. In short this is saying that there's a region at the root of the tail which is largely attached in the baseline case (but with some spanwise flow). This bubble 422 is an unsteady vortex that contains strong spanwise flow within its core. The fluid in the core originates near actuator (2) and proceeds all the way to the tail's tip joining with and reinforcing the tip vortex 424. This can be observed by following the second row the red tufts that point more upstream than the green ones and seem to be also steadier than the green ones. The closed bubble 424 creates a low pressure zone near the hinge 408 of the rudder opposite actuators (3) to (5) and when it joins with the tip vortex it spreads over the entire chord of the rudder (see FIG. 4(b)). If we assume that each actuator serves as a vortex generator provided Cμ is small, then the bubble consists of a number of co-rotating vortices that are bundled together near the surface of the rudder 402.

This model seemed to be farfetched when it was originally considered to represent the flow over the vertical tail because of the many secondary effects that polluted the visual observation. Some of these are clearly noticeable and include the root vortex created by the gap between the rudder and the tunnel floor that allows air to flow from the high pressure side of the rudder to the low pressure side; the necklace vortex created near the leading edge of the vertical tail due to its interaction with the floor boundary layer; the oscillatory nature of the actuators; the potential compressibility effects at their exits, and the interaction of the tip vortex with the spanwise rudder flow.

(i) Water Testing

To avoid these effects while promoting the universality of the phenomenon, the flow 500 with speed u over a delta wing 502 having a sharp leading edge 504 was tested in a water tunnel, as illustrated in FIG. 5. The wing was swept back at 70° and it had a 10 inch central chord. It was tested in a water tunnel that enabled easy visualization of the flow 506 while avoiding compressibility effects at the jet exits. The jets emerged from four hypodermic tubes 508 of 0.020 inch internal diameter. The tubes were placed symmetrically on both leading edges 504 of the delta wing 502 but only those on the left hand side were connected to a water source while those on the right were blocked for the sake of comparison. The water jets emerged from those tubes tangentially relative to the wing upper surface and normal to the leading edge. In absence of blowing the circulation in the leading edge vortices was symmetrical and it increased in the direction of streaming.

Vortex breakdown 510 occurred on both wings symmetrically as well (as illustrated in FIG. 5). When water was injected from the hypodermic tubes the concentrated vortex core disappeared and seemed to be replaced by a flattened bundle of vortices or a highly turbulent attached flow that covered almost one half of the wing area rather than being concentrated near the leading edge.

The demonstration carried out on the delta wing using steady jets corroborates the observations made on the rudder of the “A” model using sweeping jets at low Cμ (FIG. 4(a)).

(ii) Effect of Sweeping Jets

One may easily show that the oscillatory effects of jets sweeping motion are secondary when Sp is large and Cμ is low by blocking the feedback channels 600 on one side of the actuators 602 which attach the emanating jets to the nozzle walls located on the opposite sides of the blocked feedback channels, thus making the jets steady.

Three sets of results were generated without changing anything on the outer loft of the vertical tail:

1. The jets were steady and inclined toward the root of the tail

2. The Jets were sweeping at approximately +/−50° relative to the actuators' axis of symmetry that is perpendicular to the rudder hinge.

3. The jets are steady and inclined toward the tip which aligns them closer to the free stream.

The dependence of C_{L} corresponding to each of these conditions on Cμ is shown in FIG. 6b for Sp=12% and δ=60%. It is clear that steady jets inclined toward the root of the rudder generate the largest side force for a prescribed low Cμ input. The difference in the direction of the steady jets provided a 5% difference in C_{L} at Cμ≈0.25%, while the sweeping jet actuation halves the difference. Pressure coefficients taken on the rudder-shoulder suggest that AFC did not affect the baseline pressure close to the root (z/b≈0.1). However, the baseline flow starts to separate at z/b>0.3 with C_{P} increasing from its minimum value of −3 measured at z/b<0.2 to C_{P}=−1 at z/b>0.55. Application of AFC reduced the C_{P} along the rudder hinge to C_{P}=−4.5 for a modest level of Cμ=0.3%. The spanwise extent of this influence depends on the angle of injection of the steady jets that differed by as much as Δz/b=0.23 (i.e. the steady jets pointing to the tip retained the low C_{P} up to z/b=0.45, while the jets pointing toward the root held this value up to z/b=0.68). Since the sweeping jet results are bracketed by the two steady jet results that differ in their orientation, the effect of the sweeping motion was deemed to be secondary.

(iii) Interruption of Flow

The jet velocities emanating from each nozzle of the six actuator array are quite high even for relatively modest Cμ inputs due to the small number of the actuators used. Thus, the actuators can create jet curtains that reduce or even eliminate locally the spanwise flow at higher values of Cμ. This is clearly visible in FIG. 7(a) where the high speed jets, marked by blue arrows 700 downstream of the trailing edge of the rudder 702, penetrate the spanwise flow deflecting it along the entire rudder chord in the direction of the free stream 704. The flow just above each of the jets marked by the arrow 700 is parallel to the free stream 704, however in the vicinity of the trailing edge the flow 706 starts to turn toward the tip. It proceeds to turn toward the spanwise direction 708 attaining it in this case near the mid distance between the actuators.

Above the jet, the flow turns back toward the rudder hinge partly because of the low pressure in the hinge region and partly because of the strong entrainment by a second jet, emanating from the nozzle located above the one considered, that pulls the flow toward the hinge. Therefore cell like flow is created between each pair of actuator jets that reduces the effectiveness of a large Cμ input at large Sp. This may be avoided by switching to closely spaced actuation whenever the need arises although this entails an increase in mass flow consumed that varies proportionally as the square root of the increased spacing, provided the dimensions of the actuators do not change. One may consider changing the distribution of momentum along the span by increasing actuator size toward the tip, changing the pressure input to each individual actuator and possibly even altering the chordwise location of successive actuators. However, cell flow is one way that the fluidic fence can work. For example, One or more embodiments have a low power fluidic fence, in which the individual jets spread quickly and have a small effect on the entire wing. One or more other embodiments have a high power fluidic fence, in which the jets don't spread and instead “cut” through the spanwise flow like “jet curtains”. By increasing the number of actuators, you are then doing separation control, so this is saying “if you need more than the fence provides, you need separation control”.

(iv) Comparison with a Solid Fence on an Aircraft Wing

The reorientation of the natural flow over a swept back wing by high speed jets is most obvious when the flow is either attached or only mildly separated. The flow across a “jet curtain” according to one or more embodiments is eliminated when a strong jet reaches the trailing edge of a wing as shown in FIG. 7(a). It is therefore reminiscent of fences 710 used on early high speed jet airplane wings (see FIG. 7(b)) and will be referred to as a “fluidic fence”. A solid fence 710 spans the wing chord and redirects the flow along the free stream, thus reducing the load on the outboard portion of the wing. The influence of this solid fence 710 is very local and its effectiveness is limited.

Some fences are even wrapped around the wing's leading edge (e.g. BAC-111) because the chordwise component of the free stream comes to stagnation leaving the spanwise component intact. It is the latter that is redirected by the solid fence. Thus, the fence does not only block the vortical flow in the boundary layer but it affects the direction of the potential flow near the wing. It therefore has to extend far beyond the boundary layer thickness. Fences were mostly used to improve the maneuverability of military aircraft, but some versions of them are still in use on currently manufactured commercial jets for the prevention of wing-tip stall. Consequently fences provide some advantages at high incidence but they increase the drag during cruise. A fluidic fence on the other hand, and according to one or more embodiments of the present invention, can be switched ON or OFF on demand and one may not have to pay the drag penalty when they are in use.

The concept of a fluidic fence was based on a precept that there are two boundary layers on a highly swept-back wing, one normal to the leading edge and the other parallel to it. One boundary layer evolves in the chordwise direction and is subjected to pressure gradients that might result in flow separation as a result of incidence or large flap deflections. The other boundary layer evolves along the span of the wing that under ideal conditions of infinite aspect ratio, and in the absence of taper and twist, is akin to a boundary layer evolving over a flat plate. This oversimplified view, evolving from the boundary layer “independence principle” on infinitely yawed airfoils, suggests that the spanwise flow loses momentum as it proceeds outboard on swept back wings. This loss has to be brought under control first as it will otherwise result in flow separation somewhere along the span where the accumulated vortical low speed fluid from both boundary layers exceeds a certain threshold. Therefore swept back wings stall at an outboard location unless they are twisted, tapered and/or they have partially drooped leading edges or other devices on the outboard span (e.g. leading edge 712 on EMB 145 wing shown in FIG. 7(c). The loss of lift resulting from incipient wing-tip stall is most dangerous because of the rolling moment that it generates and because of the pitch-up caused by the tendency of the separated region to expand toward the wing-root thus moving the center of lift forward. Fences 714 can also be provided on engine nacelles, as illustrated in FIG. 7(d).

One or more embodiments of the present invention can replace these solid fences with fluidic fences.

To avoid this, the spanwise boundary layer flow has to be eliminated or reduced while the flow is still attached and the “fluidic fence” according to one or more embodiments performs this function very effectively. This was observed on the “B” model at δ=20% and Sp=15% at weak actuation providing a total Cμ=4.0% and compared to baseline configuration, as shown in FIG. 3. The separation seen at the root (left side) of FIG. 3 is the root vortex of the wing and the first fence jet is able to destroy this vortex as observed in the water experiments of the delta wing. Both sets of tufts are steady suggesting that the flow is attached (the rest of the rudder is attached), yet the spanwise flow is virtually eliminated by each consecutive actuator. The entire surface of the rudder downstream of the second row of tufts is affected by the actuation with the flow being reoriented in the chordwise direction, but the change of angle is not uniform. The biggest difference between the tufts is realized near the rudder's trailing edge where the chordwise adverse pressure gradients decelerate the chordwise boundary layer flow making the spanwise flow more noticeable. The first row of tufts near the rudder's leading edge is not affected by the sweeping jet actuation, with the exception of the tufts located immediately downstream of the actuators' nozzles, because the chordwise velocity component at the rudder's hinge is high due to the rudder's deflection. There is thus a delicate balance between chordwise pressure gradient created by rudder deflection or the incidence of the tail and the sweep-back angle of its leading edge. Clearly flow separation is not a prerequisite for the control of the spanwise flow.

A sample of the surface flow visualization carried out by [21] on a 45° sweptback wing 800 constructed from a NACA 652-615 airfoil and having an aspect ratio of six is shown in FIG. 8(a). The surface streamlines 802 shown in the absence of separation are almost tangential to the trailing edge when the wing was lifting, suggesting that the chordwise component of velocity was negligible relative to the spanwise component. When the angle of incidence was increased, resulting in flow separation on the upper surface, a fairly large region of spanwise flow was observed on each side of the mean separation line. This region covers 25-30% of the chord and its extent most likely depends on the chordwise pressure gradient (i.e. it depends on the shape of the airfoil and its incidence). This observation differs from the traditional separation concept on swept back wings that was provided by [22] who neglected the wide region that is dominated by spanwise flow on both sides of the “separation line”.

Flow visualization 804 over a wing of a commercial twin engine model also points out the significance of the spanwise flow over the wing prior to separation (FIG. 8(b)). It is interesting to note that the flow 806 over the flaps of this model is entirely separated and this separation might have been instigated by the low momentum fluid coming from the wing root.

Also shown in FIG. 8(a) is the stagnation line 804, leading edge 806, transition 808, spanwise flow region 810, trailing edge 812, and section side 814.

The above results show the importance of altering the direction of span wise flow according to one or more embodiments of the invention.

(v) Comparison of Fluidic Fence with Separation Control

FIG. 9 shows the setup of the vertical stabilizer 1000 in the Lucas wind tunnel 1002 (showing wind direction 1004) using a sweeping jet actuator as illustrated in FIG. 10 as the devices to generate the secondary fluid flow structures in the measurements shown in FIG. 11. FIG. 10 illustrates the sweeping jet actuator comprises a supply 1000, power nozzle 1002, control port 1004, feedback path 1006, interacting region 1008, and outlet 1010 (see also [23] for further information). Such a sweeping jet actuator is used to obtain the results presented in this disclosure.

One may maintain a constant average momentum input for a given chamber pressure by either changing the actuator size or changing the distance between adjacent actuators. FIG. 11 shows the effects of spacing, Sp, on actuators with an orifice size of 0.6 at a prescribed δR=60%. For a given Cμ<0.8%. increasing the distance between adjacent actuators increases the CYn generated by the vertical tail. At very low Cμ, an increase in spacing implies a substantial increase in Uj that lowers the threshold level at which the jet starts entraining ambient fluid, but it also provides a jet curtain that stops locally the spanwise flow along the rudder. This is not apparent from the integral values that consider the entire surface of a wing or the rudder. The reorientation of the flow in the direction of streaming (green tufts in FIG. 10c) and the corresponding effect it has on the production of side force by the vertical tail might be specific to the interaction between backward sweep of a wing and high speed actuation. This could not have been observed on a straight wing or on a tapered one and in this case the sweeping motion of the jets may even be detrimental to the reorientation process. By quintupling the distance between actuators to 15% one may generate a 20% improvement in CYn at CQ=0.01% or Cμ=0.1%. Tufts indicate that the flow changes direction at the lowest Cμ measurable. At high Cμ the individual jets reach the trailing edge of the rudder, creating cells of partly recirculating chordwise flow. However, at high Cμ the actuators may have already redirected the local spanwise flow. The sparsely spaced nozzles choke early and shocks may appear at their exit partially accounting for the rapid decrease of the slope.

FIG. 12 shows that in a situation with separated flow, a fluidic fence system has a characteristic behavior when compared to a separation control system. With a fluidic fence, the lift increase will be very high at low momentum input (flow redirection regime) and level at high momentum input (flow interruption regime). Conversely, a separation control system will show little or no lift increase at low momentum and very high lift increase at high momentum. As indicated in FIG. 12, the momentum required in a separation control system to achieve the lift increase of a fence system in the flow redirection regime is on the order of 10 times higher than that of the fence system.

These characteristic curves distinguish the fluidic fence from a separation control system when applied to situations where the flow is separated.

When the flow is already attached, separation control and fence systems show similar behavior in terms of the force increase. In other words, from the point of view of lift increase, they are indistinguishable from each other. However, one must recall that in the data we present, the fluidic fence system uses nominally 5 times less actuators than does a separation control system employing identical actuators.

Conventional means of fluid control tries to attach separated flow while the fence according to one or more embodiments of the invention tries to redirect it whether it is separated or not. It is significantly different and in several decades of flow control research no one to our knowledge has realized that redirecting flow over wings for example is beneficial. Everyone has been striving to energize the boundary layer or blow it away or suck it off in order to delay separation.

Possible Modifications

The jets which are used to form the fluidic fence can take a variety of forms. They can be:
simple orifices (subsonic jets);
supersonic nozzles;
sweeping jets (changing angle or position with time), either mechanical or in the style of a fluidic amplifier;
pulsating jets (changing intensity and/or size with time), either mechanical or in the style of a fluidic amplifier, such as one with discrete outlet ports;
Any combination of the above, such as a pulsating, sweeping, supersonic jet.

Examples of devices that can be used to generate the secondary fluid flow structure are described in Table 1 on page 225 of [12].

The aerodynamic surface need not be a wing. In terms of the descriptive embodiment on a swept wing, it should be noted that “wing” is defined as “an aerodynamic surface that produces a force” such that a vertical tail, horizontal tail, canard fins, stabilizer fins, dorsal fins, keels, rudders, rotors, propellers, fans and turbines (particularly wind turbines), etc. On an airplane, for example, the sweep on the vertical tail also exhibits the same separation characteristics (i.e. separation at the tip first) as a swept main wing, and thus the fluidic fence is applicable there. It should also be noted that the position or sweep direction of the wing should not affect the validity of the fluidic fence approach although it will certainly affect its optimal design; for example canard configurations with elevators in front could still benefit from fluidic fences.

As described above, the application of the fluidic fence is not limited to wings and rotors. Situations in which the flow direction should be changed as a function of the conditions can benefit from a fluidic fence system. These include fan/engine intakes, diffusers, spoilers, the hulls of ships and submarines, hydroelectric turbines, piping/ducts, etc. Examples are:
diffusers/splitters on, for example, racing vehicles, where performance benefits may be found by replacing some of the solid surfaces with fluidic fences;
intake and exhaust vents, such as the commonly used NACA vent, where fluidic fences could be used in place of solid surfaces to divert air into or out of the vent, even to the extent that the fluidic fence may be turned on and off to completely enable or disable a vent or select between different vents, such as diverting air towards an auxiliary radiator when engine temperature is high;
inside axial or centrifugal compressors, where fluidic fences could be used to manipulate swirl in order to, for example, aid stator blades;
inside ducting, to aid the mixing or transfer of fluids, where, for example, fluidic fences could be used to increase mixing, or, in the case of filling a tank with liquid, to spin the fluid as it goes through the opening so that air can pass through the center of the vortex to avoid gurgling;
inside gas separation centrifuges, where fluidic fences could be used to delicately alter the vorticity distribution in order to aid the inertial separation process;
along the length of long spans such as chimneys and refueling booms;
on propellers, windmills, and helicopter rotors, where the constant rotational speed gives rise to flow fields very similar to those found on swept wings;
on the outer shroud of modern turbofan engines, where currently rigid (thus optimized for only one speed) fences are placed to reduce swirl.

FIG. 13(a)-(b) illustrate a fluidic fence used to reduce flow into an intake 1300, according to one or more embodiments, wherein FIG. 13(a) shows the normal flow (fence OFF); streamlines 1302 show flow easily entering the vent 1304 and FIG. 13(b) shows the fence ON. A the secondary flow structure (1) 1306 interrupts the flow 1302 going into the vent causing the flow to separate 1308 at the inlet of the intake (2) so that the high speed flow 1310 goes over the intake 1300 instead of into it. The separation bubble 1308 generated at the inlet of the intake could be carefully tuned by controlling the fence device so that drag due to the intake is reduced.

FIGS. 14(a)-(b) show a fluidic fence used to increase flow into an intake 1400, according to one or more embodiments, wherein FIG. 14(a) shows the normal flow (fence OFF). This shows an intake in cross-flow 1402 (flow at the wrong angle) which can happen, for example, on airplanes making sudden maneuvers. The inlet 1404 of the intake is essentially at the wrong angle and thus the amount of flow ingested is reduced; we show some separation 1406 in the inlet as the air flows 1402 over the sharp edge (1). FIG. 14(b) shows the fence ON. A strong fluid structure (2) 1408 helps to redirect flow so that it is more parallel 1410 to the intake (3) thereby increasing flow ingestion. Because the fluidic fence device can be controllable in both strength and direction independent of the primary flow the exact amount of flow redirection can be tuned to the specific situation.

Thus, FIGS. 13 and 14 illustrate a method for controlling or diverting primary flow 1302, 1402 into or away from an intake 1300, 1400, comprising using one or more devices generating one or more secondary fluid flow structures 1306, 1408, wherein the secondary fluid flow structures have a strength that is controlled independently of the primary flow, and vary an amount of primary flow entering the intake by changing direction of said primary flow, and/or interrupting and re-starting said primary flow. In one or more embodiments, the devices can be on the surface on which the intake 1300, 1400 is placed/disposed, or in one or more embodiments the secondary fluid flow structures can emanate from the surface on which the intake 1300, 1400 is placed/disposed.

In one or more embodiments, the intake can be an engine intake, cooling intake, or radiator intake, or intake for a fan on a car. The intake can be switched on or off using the fluid flow structure.

FIGS. 15(a)-(b) shows fluidic fence system on a rotor blade 1500, according to one or more embodiments. FIG. 15(a) shows a possible flow field on a rotating airfoil, for example, on a wind mill, propeller, compressor, turbine, helicopter rotor, etc., with the fence system OFF. Due to the constant rotational velocity (1) the flow encountered by the blade changes with the radial (spanwise) position, so that spanwise flow (2) can exist (and vary along the span) even with an unswept blade. FIG. 15(b) shows the fence system ON. Because the devices' strength and direction are controllable independent of the primary flow, we could see, for example, fence devices in interruption mode (3) near the root of the blade, where the spanwise flow is able to develop between the fluidic fences (4). Near the tip of the blade the fences could be operated in flow redirection mode (5) just to reorient the flow to be more perpendicular to the leading edge. Which fences are used for interruption and which are used for redirection could be varied with the flow conditions.

FIGS. 16(a)-(b) show a fluidic fence system on a swept wing 1600, according to one or more embodiments. FIG. 16(a) shows a fluidic fence system in the redirection regime. The flow structures (1) serve to redirect the flow from the normal path (2) to the new path (3), which may still contain a substantial spanwise component. The figure shows an exaggerated redirection as in many cases a change in flow angle of ˜5 degrees can already increase lift significantly (˜20%). FIG. 16(b) shows a fluidic fence system in the interruption regime. Stronger fluid structures (4) serve to reset (5) the spanwise flow but still allow it to develop in the regions between fluidic fence devices (6).

FIGS. 1-3, 11, 12, and 13-15, 16, and 17 illustrate examples of methods and systems of altering primary flow direction over aerodynamic and hydrodynamic surfaces generating force. The method can comprise the following steps.

Block 1700 of FIG. 17 illustrates providing primary flow direction over aerodynamic and hydrodynamic surfaces generating force (or into/out of an intake).

Block 1702 represents using one or more devices to generate one or more secondary fluid flow structures. The secondary fluid flow structures can emanate from a aerodynamic or hydrodynamic surface, have a strength that is controlled independently of the primary flow, and enhance the aerodynamic or hydrodynamic force generated by primary flow predominantly by: changing direction of said primary flow whether the flow is attached or separated from the surface, and/or interrupting and re-starting said primary flow forming regions that are not directly affected by the fluid flow structure regardless of whether said primary flow is attached or separated.

The changing of the direction can be along the aerodynamic or hydrodynamic surface and may be substantially not normal to the surface.

The aerodynamic force can be enhanced without the use of mechanical devices that alter contours of the surface. The fluid flow structure can prevent separation by redirecting the primary flow, thus using less energy than is required to generate a fluid flow structure that can re-attach the primary flow. The fluid flow structure can be generated using less energy than is required to generate a fluid flow structure that can re-attach the primary flow (e.g., the energy may be no more than 15% of that required to re-attach the primary flow, and/or the secondary fluid flow structures can directly affect 20% or less of the primary flow).

In one or more embodiments, most of the primary flow may still separate from the lifting surface but the aerodynamic force generated has still increased.

The fluid flow structure can be generated by at least one of a jet of fluid, a synthetic jet actuator, a sweeping flow actuator, a plasma actuator, unsteady valves, oscillators, combustion, piezoelectric flaps, active dimples, single dielectric barrier discharge, spark jet, or electromagnetic interference.

The aerodynamic surface can be rotating (e.g., as used in a windmill, compressor, turbine, propeller). The aerodynamic surface can be a helicopter rotor blade and the aerodynamic force can be lift or a side force.

One or more embodiments can use a single secondary fluid flow structure consisting of one fluid stream extending along a chordwise direction and at a spanwise location.

In one or more embodiments, one or more locations of the devices can generate the secondary fluid flow structures that divide the surface into equal spanwise sections.

The direction of said primary flow over the surface can be changed from a span wise direction towards a free-stream direction. The primary flow that is interrupted can be primarily in a spanwise direction.

The fluid flow structure can comprises at least one fluid stream generated at a leading edge of the aerodynamic surface comprising a wing and extending along an entire chord of the wing.

The fluid flow structure can change the direction of said flow when said flow is attached and separated.

In one or more embodiments, the devices do not change the outer shape of the wing even when the strength of the fluid flow structure changes (i.e. no moving parts exposed to the primary flow).

The wing sweep angle can be over 30 degrees, for example (e.g., 45 degrees).

Advantages and Improvements

The quest for speed brought forth the swept back wing design that allowed for a flight at high subsonic speeds thus delaying the drag rise associated with the formation of shock on the wings' upper surface. However swept back wings provided another challenge because they tend to stall first near the outboard section of the wing. This has two undesirable effects: a possible wing drop due to asymmetric stall and a nose pitch up at the first stages of stall. On a typical straight wing airplane the center of gravity is located upstream of the center of lift and the latter does not move much during stall, so when the airplane stalls the nose drops automatically and the airplane gathers speed and may recover without the intervention of the pilot. A stall on a swept back wing aircraft that starts at the outboard portion of the wing and progresses inboard results in a forward motion of the center of lift that pitches up the nose of the airplane thus exacerbating the stall. Thus one of the challenges of a wing designer is to assure that the root of the wing stalls first.

One of the early remedies designed during the nineteen fifties and sixties was the “boundary layer fence” that extended well beyond the boundary layer in height and was sometimes even upstream of the wing itself. They were used on MiG family of aircraft, on delta wings (e.g. F102) and on commercial airplanes (e.g. BAC 111 and Trident). They realign the local flow in the direction of the free stream but their effect is minor and their drag penalty is substantial. The fences also act as large vortex generators since the spanwise component of the flow that these fences interfere with locally generate a vortex in their wake. Thus, ideally, the fence should have redirected the flow toward the wing root but that would have caused prohibitive drag.

On today's Boeing airliners a fence and sometimes two fences (Boeing 737-800) are placed on the inboard portion of the engine nacelle because they more effectively push the flow toward the wing root [1]. A fence that is inclined to the flight direction could have had a similar effect except that its drag would have been prohibitive.

Vortilons are effectively wing fences that are attached to the underside of the wing and they protrude upstream of the leading edge. They align locally the flow with the flight direction but their drag penalty is smaller since the local flow speed is lower than it is on top of the wing. At high angles of incidence (i.e. at a reduced speed) they generate vortices, that follow the wing's upper surface, that divert the flow, and reduce the spanwise component of velocity on the upper surface. Vortilons were used to ameliorate the deep stall problem on the DC-9 and they are currently used on the ERJ 145 family of jets. In this case four vortilons are placed on the wing upstream of the airplane's ailerons.

There are other devices that create large vortices that change the lift distribution on swept back wings of various configurations. Most of these devices are prominent on military aircraft that cruise at subsonic speeds but are capable of high speed dash whenever the need arises. Most of these airplanes rely on concentrated vortices for their lift generation (e.g. delta wings) that are stationary over most of the flight envelop. These include saw tooth leading edges and droops (e.g.F-4), strakes on the fuselage (e.g. F-5), large strakes that evolved into cranked wings (F-18), and canards (e.g. Rafale; Eurofighter) [2-3].

All fences, canards and other similar devices represent surfaces that generate drag when they are not required. The use of these devices is required only during specific maneuvers and on civilian aircraft they are only needed during takeoff and landing. It has been suggested to retract them during cruise [4]. However, this adds weight, increases complexity and adds to the cost in terms of installation and maintenance. One or more embodiments of the present invention do not add external surfaces to wings, diffusers or nacelles and there is no need to retract them.

One or more embodiments of the present invention relate to a method and apparatus used to increase the lift on wings and in particular on swept back wings by reducing the spanwise component of the flow on the wing. One or more embodiments delay separation on the outboard portion of the wing, but their primary function is not to attach the flow that is already separated. Thus, one or more embodiments of the present invention may be used to generate forces and moments which will enhance the load carrying efficiency of the particular section of the wing or the maneuver capability of the entire craft.

U.S. Pat. No. 4,257,224 [5] describes a method and apparatus for enhancing the mixing of two fluids by providing flow perturbations near the origin of the mixing region about an axis substantially normal to the prevailing flow direction. Examples of possible uses of the technique described in that patent include promoting combustion in burners, jet engines etc. and increasing the output of ejector pumps.

U.S. Pat. No. 5,209,438 [6] describes a method and apparatus exploiting the technique for enhancement of mixing to delay separation or enhance the reattachment of a boundary layer that already separated from a solid surface. The technique described in [6] includes the ability to increase the divergence angles of diffusers as well as the deflection of flaps and control surfaces, thus increasing the pressure recovery in diffusers and the lift to drag ratio of wings. In most cases the wings were not swept and therefore the oncoming flow was substantially normal to the leading edge of the wing.

Methods and apparatus to be used for thrust vectoring and controlling the motion (in both direction and attitude) of an aircraft, a missile or an underwater vehicle can be achieved by partial or differential application of the above mentioned technique to lifting surfaces, nozzles or diffusers. For example, by attaching the flow to one surface of a wide angle diffuser (or nozzle), the emerging flow is attached only to that particular surface and is therefore inclined to the plane of symmetry of the above mentioned nozzle. A differential application of the enhancement of lift technique to each of the wings of an aircraft creates both rolling and yawing moment and allows the aircraft to turn in a coordinated manner without the use of conventional ailerons [7].

Most of the previous work uses periodic perturbations generated by synthetic jets or zero mass flux actuators. These devices were even tested on a tilt rotor aircraft (the XV-15 for download alleviation purposes in hover) in 2003. The use of sweeping jet actuators for the purpose of preventing flow separation from flapped wings and reducing download was tested in 2005-2008 and the results were published by [8]. This publication disallows any patents that use sweeping jets for separation control.

One or more embodiments of the fluidic fence have an advantage over conventional methods in that the strength is controlled independently of anything else.

Another benefit of one or more embodiments of the invention that the orientation of the fence is also controllable. A rigid fence is aligned in a fixed direction. A jet fence, for example, could be made to change orientation depending on free stream speed (in a passive or active manner). If you blow a jet at some angle to a stream, the proportion of the free stream speed to that of the jet will define how the jet “bends” into the stream. At some large distance from the source, the jet will be parallel to the stream, but it's quite likely that over the wing it will be curved.

The orientation control can also be active. For example, if a fluidic amplifier is used as the actuator, then the output jet can be steered using auxiliary control jets inside the amplifier (no moving parts).

### REFERENCES

The following references are incorporated by reference herein.
[1] U.S. Pat. No. 4,540,143.
[2] U.S. Pat. No. 3,471,107.
[3] U.S. Pat. No. 5,037,044.
[4] U.S. Pat. No. 8,087,617B2.
[5] U.S. Pat. No. 4,257,224.
[6] U.S. Pat. No. 5,209,438
[7] AIAA Journal of Aircraft 36, 474-477, 1999.
[8] Lucas, N., Taubert, L., Woszidlo, R., Wygnanski, I., and McVeigh, M. A., “Discrete Sweeping Jets as Tools for Separation Control,” 4^{th} Flow Control Conference, Seattle, Wash., AIAA 2008-3868, Jun. 23-26, 2008.
[9] U.S. Patent Publication No. 20120091266 by Whalen.
[10] U.S. Pat. No. 8,382,043 by Raghu
[11] U.S. Pat. No. 7,686,257 by Saddoughi.
[12] Annu Rev. Fluid Mech. 2011. 43:247-72 by Cattafesta and Sheplak.
[13] http://adg.stanford.edu/aa241/drag/sweepncdc.html.
[14] http://en.wikipedia.org/wiki/File:USAF_MiG-15.jpg showing a MiG 15 (captured by the United States) and showing two prominent wing fences.
[15] MiG 15 schematic with fences, taken from http://www.the-blueprints.com/blueprints-depot/modemplanes/mikoyan-gurevich-mig/mikoyan-gurevich-mig-15-2.png.
[16] F102 showing a partial fence about ⅓ of the span and a full fence at about ⅔ span (http://en.wikipedia.org/wiki/File:Convair_YF-102_on_Ramp_E-2550jpg).
[17] Sud Aviation Caravelle; one of the first jet-liners (http://it.wikipedia.org/wiki/File:Sud_Aviation_Caravelle_III_3-view.svg)
[18] When the prop-driven Northrop X/YB-35 evolved into the jet-powered YB-49, fences had to be added due to the removal of the large piston-engine nacelles. Shown is the YRB-49 (http://commons.wikimedia.org/wiki/File:YB49-8_300.jpg)
[19] Northrop YB-49 (large) and XB-35 (small), showing how the removal of the prop shaft housings and the air stream generated by the propellers necessitated the addition of fences in the jet powered version. Taken from http://img687.imageshack.us/img687/258/northropyb49flyingwing1.jpg.
[20] U.S. Pat. No. 4,540,143, see e.g., FIGS. 4-6, showing combination vortex generator and fence on nacelle used to control the wake of the same over the wing behind it. The vortex then limits the expansion of the wake over the wing.
[21] Gronau, K. H., and Nickel, K., “Experimentelle Untersuchungen an schiebenden und gepfeilten Flügeln mit Normal- und Laminar-Profilen (Experimental Investigations of Yawing and Swept Wings with Normaland Laminar Profiles),” Deutsche Forschungsanstalt für Luftfahrt e.V., Rept. 56/14, Braunschweig, Germany, 1956.
[22] Hoerner, S. F., “Einfluβ der Pfeilstellung auf die Uberziehbarkeit der Tragflügel (Influence of Sweep on the Stall Behaviour of Wings),” Deutsche Versuchsanstalt far Luftfahrt e.V., Rept. PB-392, Berlin, 1936.
[23] Sweeping Jet actuators—a New Design Tool for High Lift Generation, http://ntrs.nasa.gov/archive/nasa/casi.ntrs.nasa.gov/20130013994.pdf.
[24] Raman, G. and Raghu, S., “Cavity Resonance Suppression Using Miniature Fluidic Oscillators”, AIAA Journal, doi:10.2514/1.521, Vol. 42, No. 12, December 2004, pp. 2608-2611.
[25] Performance Enhancement of a Vertical Tail Model with Sweeping Jet Actuators, Jan. 7, 2013, http://ntrs.nasa.gov/search.jsp?R=20130003329.
[26] http://arc.aiaa.org/doi/abs/10.2514/6.2012-3244, Improving Rudder Effectiveness with Sweeping Jet Actuators, Jun. 25-28 2012.
[27] Greenblatt and Wygnanski, Progress in Aerospace Sciences 36 (2000) 487-545.
[28] http://www.desktop.aero/appliedaero/viscous3d/b13d.html.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of altering primary flow direction over an aerodynamic or hydrodynamic surface generating force, comprising:
using one or more devices to generate one or more secondary fluid flow structures, wherein the fluid flow structures:
emanate from the aerodynamic or a hydrodynamic surface,
have a strength that is controlled independently of the primary flow, and
enhance the aerodynamic or hydrodynamic force generated by the primary flow predominantly by changing direction of said primary flow whether the primary flow is attached or separated from the aerodynamic or hydrodynamic surface.

2-6. (canceled)

7. The method of claim 1, wherein the secondary fluid flow structures are generated using less energy than is required to generate a fluid flow structure that can re-attach the primary flow.

8. The method of claim 7, wherein the energy is no more than 15% of that required to re-attach the primary flow.

9. The method of claim 1, wherein most of the primary flow may still separate from the lifting surface but the aerodynamic force generated has increased.

10-15. (canceled)

16. A method of altering primary flow direction over an aerodynamic or hydrodynamic surface generating force, comprising:
using one or more devices to generate one or more secondary fluid flow structures, wherein the fluid flow structures:
emanate from the aerodynamic or hydrodynamic surface,
have a strength that is controlled independently of the primary flow, and
enhance the aerodynamic or hydrodynamic force generated by the primary flow predominantly by interrupting and re-starting said primary flow forming regions that are not directly affected by the fluid flow structure regardless of whether said primary flow is attached or separated.

17. (canceled)

18. The method of claim 16, using less of the devices than are required to re-attach the primary flow.

19-20. (canceled)

21. The method of claim 16, further comprising using a single secondary fluid flow structure consisting of one fluid stream extending along a chordwise direction and at a spanwise location.

22. (canceled)

23. The method of claim 16, wherein the primary flow that is interrupted is primarily in a spanwise direction.

24. A system for controlling fluid flow , comprising:
one or more devices generating one or more secondary fluid flow structures, wherein the secondary fluid flow structures:
emanate from the aerodynamic or hydrodynamic surface,
have a strength that is controlled independently of the primary flow, and
enhance the aerodynamic or hydrodynamic force generated by the primary flow predominantly by:
changing direction of said primary flow whether the primary flow is attached or separated from the surface, and/or
interrupting and re-starting said primary flow forming regions that are not directly affected by the secondary fluid flow structure regardless of whether said primary flow is attached or separated.

25. A method for controlling or diverting primary flow into or away from an intake, comprising:
using one or more devices generating one or more secondary fluid flow structures, wherein the secondary fluid flow structures:
have a strength that is controlled independently of the primary flow, and
vary an amount of primary flow entering the intake by:
changing direction of said primary flow, and/or
interrupting and re-starting said primary flow.

26. The system of claim 24, wherein the changing of the direction is along the aerodynamic or hydrodynamic surface.

27. The system of claim 24, wherein the changing of the direction is substantially not normal to the aerodynamic or the hydrodynamic surface.

28. The system of claim 24, wherein the direction of said primary flow over the aerodynamic or hydrodynamic surface is changed from a span wise direction towards a free-stream direction.

29. The system of claim 24, wherein the aerodynamic or hydrodynamic force is enhanced without the use of mechanical devices that alter contours of the aerodynamic or hydrodynamic surface.

30. The system of claim 24, wherein the secondary fluid flow structures re-direct the primary flow, thus using less energy than is required to generate a fluid flow structure that can re- attach the primary flow.

31. The system of claim 24, wherein the secondary fluid flow structures are generated using less energy than is required to generate a fluid flow structure that can re-attach the primary flow.

32. The system of claim 31, wherein the energy is no more than 15% of that required to re-attach the primary flow.

33. The system of claim 24, wherein most of the primary flow may still separate from the lifting surface but the aerodynamic force generated has increased.

34. The system of claim 24, wherein the secondary fluid flow structures are generated by at least one of a jet of fluid, a synthetic jet actuator, a sweeping flow actuator, a plasma actuator, unsteady valves, oscillators, combustion, piezoelectric flaps, active dimples, single dielectric barrier discharge, spark jet, or electromagnetic interference.

35. The system of claim 24, using less of the devices than are required to re-attach the primary flow.

36. The system of claim 35, wherein the number of the devices is at most four times less than that required to re-attach the primary flow.

37. The system of claim 24, wherein the aerodynamic surface is rotating.

38. The system of claim 24, wherein the secondary fluid flow structure is a single secondary fluid flow structure consisting of one fluid stream extending along a chordwise direction and at a spanwise location.

39. The system of claim 24, wherein one or more locations of the devices generate the secondary fluid flow structures that divide the aerodynamic or hydrodynamic surface into equal spanwise sections.

40. The system of claim 24, wherein the primary flow that is interrupted is primarily in a spanwise direction.
